(19) United States
(12) Patent Application Publication
(10) Pub. No.: US 2004/0022258 A1
(43) Pub. Date: Feb. 5, 2004

(54) System for providing access control platform service for private networks

(75) Inventors: Maki Tsukada, Mountain View, CA (US); Atsushi Takeshita, Sunnyvale, CA (US); Kaori Murakami, Sunnyvale, CA (US)

Correspondence Address: Tadashi Horie, Brinks Hofer Gilson & Lione, NBC Tower, Suite 3600, P.O. Box 10395, Chicago, IL, 60610, US

(73) Assignee: DoCoMo Communications Laboratories USA, Inc.

(21) Appl. No.: 10/209,017

(22) Filed: Jul. 30, 2002

(51) Int. Cl. H04L 12/56

(52) U.S. Cl. 370/401

(57) ABSTRACT

A NSP network is disclosed for providing a platform service for providing data communication security in an IP-based communications network. The platform service includes connections to various private networks, a subscriber data management unit for managing information about the mobile terminals using the network, and a platform unit. The platform unit determines from the subscriber data management unit the status of the mobile terminals requesting connections to private networks and the status of the mobile terminals for which private networks target for connection. The platform unit includes applications for querying the subscriber data management unit for subscriber status, applications to command the transmission of authorization data, and applications to provide secure virtual private network communication lines for connecting the mobile terminals and the private networks.

### BACKGROUND

Along with the growth of the Internet and mobile computing, it has now become possible for a user of a mobile terminal device, for example, a laptop computer, a personal digital assistant, and an enhanced cellular phone, to connect that device to a local area network (LAN) in the home corporate office. This connection may be accomplished using public communications networks such as mobile communications networks and wireless LAN in combination with the Internet. This has greatly enhanced the efficiency of the employee, especially those in the corporate sales forces throughout the world. The employee utilizes communication systems such as mobile terminal-to-corporate-LAN connections, which enables the employee working away from the office to use all resources accessible through the corporate LAN, as if the employee was working in the office. Alternatively, the corporate LAN system might communicate with the employee's mobile terminal, making available to the employee, electronic mail (e-mail) as it arrives at the office. The e-mail is automatically transmitted to the mobile terminal in the field without the employee having to log into the system and request the e-mail or other vital information using the necessary personal IDs and passwords.

New software systems schedule events that automatically update an employee's schedule as it is displayed to the employee on the mobile unit. For some time now, mobile devices have had the ability to receive immediate alerts to news events or even the “streaming” of stock market prices “in real time.” These alerts are not freely available, but are generated through privately-owned news organizations which make these services available for a fee. These services communicate the data to member subscribers, and the owning entity attempts to retain a level of security so that non-members may not pirate the information. Building complete, independent networks is an expensive proposition, therefore these organizations utilize existing public networks and utilize security measures such as member IDs and passwords to prevent public dissemination of the valuable information. In the past, this authentication is normally performed by an access server within the private network, validating the ID and password. Alternatively, where the mobile terminal uses a mobile communications network, the caller number of the mobile terminal identifies the subscriber but to gain access to the private network, the ID and password may still be utilized. There is a need for a system that provides a smooth transition for the communication of that change.

### BRIEF SUMMARY

A secure data communication authentication method is disclosed that improves the security of communications between mobile communication terminal devices and private local area networks by authenticating the mobile terminal identification with the member's network service provider (NSP). When the owner of a mobile terminal subscribes to a private network, that information is passed to the NSP which registers the associated memberships. When the mobile unit requires a connection to the LAN, the LAN contacts the NSP to determine whether the mobile unit is a subscriber or has some relationship with the LAN and whether the request to communicate with the LAN is authorized.

This security methodology immunizes the need for IDs and passwords by registering the member's authorized access to private LANs with the member's mobile terminal network access provider. The LAN may include a personal, corporate, regional, school or subscriber-accessible network or a combination of them. When the member accesses any one of them, the targeted LAN sends a request to the NSP for an authentication, or for connection authorizing data, from the NSP before communication with the requesting device proceeds.

The authentication process begins after the mobile terminal has made contact with the gateway of the targeted LAN through IP-based communication networks. The LAN contacts the member's mobile terminal's NSP, whether it is a wireless, Internet or virtual private network (VPN), to determine whether the requesting mobile terminal is authorized access to the LAN. If access is authorized, the NSP platform service executes the methodology for providing connection control via the network access server (NAS) for the mobile terminals and the path required by the targeted LAN based on the security protocol.

The NSP platform service stores and manages subscriber information for member mobile terminals and the private LANs also subscribing to the NSP platform service. Relationships are established for the two different types of ID associated with the type of equipment. The first includes the mobile terminal IDs (UIDs) generated for mobile terminals by the NSP. The second includes the IDs for the local area network (LANIDs) generated for various private networks. The LANIDs are assigned relationships to UIDs so that the NSP may identify which LANs are associated with which mobile terminals, and vice versa. With each relationship a plurality of constituents (employees, family members, members of services, etc.) are identified within the NSP having permission to connect to the various private networks. By using the stored subscriber information for connection control between mobile terminals and private LANs, a connection control function is realized such that some connections established between the mobile terminals and the various private networks may have a high level of security. Access will be either allowed or not, depending upon the subscriber relationship information within the NSP.

A communication may originate between a mobile terminal to a private LAN when a request from a mobile terminal to a private network occurs. This could result from an employee contacting his employer's network to write an e-mail. Alternatively, the communication may also be requested by a private network to the mobile terminal, either from the network itself or from a device attached to the private network. A communication may originate at the employer's LAN and is communicated to the mobile device through the Internet or wireless service providers. This communication methodology allows other employees to efficiently communicate to mobile devices throughout the corporation, coordinate activities, and make the information available to all employees in the field without ever contacting individual employees personally.

Moreover, this methodology is not limited to the office environment. The systems currently in development will soon enable household facilities to be managed from remote locations by connecting mobile terminals to residential LANs for monitoring and controlling computerized appliances and utilities, and to transmit status information from a residential system controller to the homeowner's mobile terminal while the owner is away from home. This allows homeowners to adjust the temperature of the house before arrival or even cook dinner while traveling home from work or shopping. Alternatively, the homeowner's LAN may communicate with the homeowner's mobile terminal alerting the homeowner to any household problem.

Much of the data communication that occurs between all the devices described is through open connections via the Internet or through VPN connections if that capability exists. Connection control and authentication of the mobile terminal will be performed at the entry portal to the private network in order to establish the communication connection. In an IP-based communications network, the network access server (NAS), or equivalent access router which is connected to the mobile terminal, maintains knowledge of the current “care-of” address for the mobile terminal. If the requested connection is authorized, the platform unit sends a command to the network access server (NAS) or other equivalent access router to which the mobile device is connected, requesting that the NAS, or access router, issue connection authorization data for the mobile terminal. An example of a connection authorization data transmission includes the data generated from the global IP address of the mobile terminal for packet filtering by the source IP address, e.g. the TCP port numbers of packets that are allowed to pass through to the device in the network.

The platform unit also transmits connection authorization data to the gateway unit in the private network. The transmission may be simultaneous. The gateway unit in the targeted private network performs connection control thus providing the mobile terminal with access. Data is then sent from the mobile terminal to the device within the private network, (the device to which the connection was requested), and communication begins.

As an example, when a connection is authorized by the platform unit and if the security policy of the private network requires a virtual private network (VPN) or an equivalent connection, then the platform unit or the NAS may establish the VPN connection between the NAS, or equivalent access router, connecting the mobile terminal and the gateway unit in the private network. This may depend upon the capabilities of the NAS attached to the mobile terminal, or the private network that is being queried.

As another example, a private network might request a connection to a mobile terminal. When the request to connect one of the devices in a private network to a mobile terminal is generated, the request is initially received by the gateway unit in the private network. The gateway unit then communicates that request to the platform unit in the NSP. As a result, the platform unit queries the subscriber data management unit to determine if the requested connection between the private network and the mobile terminal is authorized. If the requested connection is authorized, then a connection is established as described above. In response to the security requirements of the private network system or from the platform unit, the NAS, or access router, can establish a VPN-type connection to the device in the private network. The connection to the mobile terminal may be provided through the NSP network high security path for closed networks.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The communication security authentication system can be better understood with reference to the following drawings and descriptions. The components in the figures are not necessarily to scale, the emphasis instead being placed upon illustrating the principles of the invention. Moreover, in the figures, like reference numerals designate corresponding parts throughout the different views. In the drawings:

FIG. 1 is a block diagram of an interconnect configuration example illustrating the connectivity between the net service provider, the local area networks and the private networks, and the devices on the private networks.

FIG. 2 is a diagram illustrating part of the data managed by the subscriber data management unit and the NAS (or access router).

FIG. 3 is a flow diagram depicting a connection from a mobile terminal to a corporate LAN describing the hierarchy and the steps to provide an authenticated communication connection between the mobile terminal device and the corporate LAN as requested by the mobile terminal device.

FIG. 4 is a flow diagram of a residential LAN requesting a connection with a mobile terminal describing the hierarchy and the steps to provide an authenticated communication connection between them.

FIG. 5 is a flow diagram describing the steps performed by the platform unit of the network service provider to provide a data communication connection between the temporary office LAN with an attached mobile terminal device and the home office LAN at the request of a PC installed on the temporary office LAN.

FIG. 6 is a flow diagram describing the steps to realize a connection between a residential LAN and the mobile terminal at the request of an alarmed intruder sensor.

FIG. 7 is a flow diagram describing the steps to realize a connection between a corporate office LAN and a retail store's LAN at the request of a database on the corporate office LAN.

### DETAILED DESCRIPTION

A communication security authentication system is disclosed that provides a straight-forward, secure integrated methodology for the connection of mobile terminals to private local area networks. The private LANs may include those owned by corporations, schools, home owners for providing access to household appliances and home computers, or service LANs that provide member-only services such as news or market data research. The request for a connection can originate at the mobile terminal, the LAN or from a device that is connected to a LAN. In order to implement this method an interconnect configuration should exist between the network service provider for the mobile terminal and the private LANs. Also, a current member listing of the private networks for a given mobile terminal exists at the NSP. By making use of the subscriber data in the possession of the NSP, the mobile terminal and the networks can establish communication connections as needed.

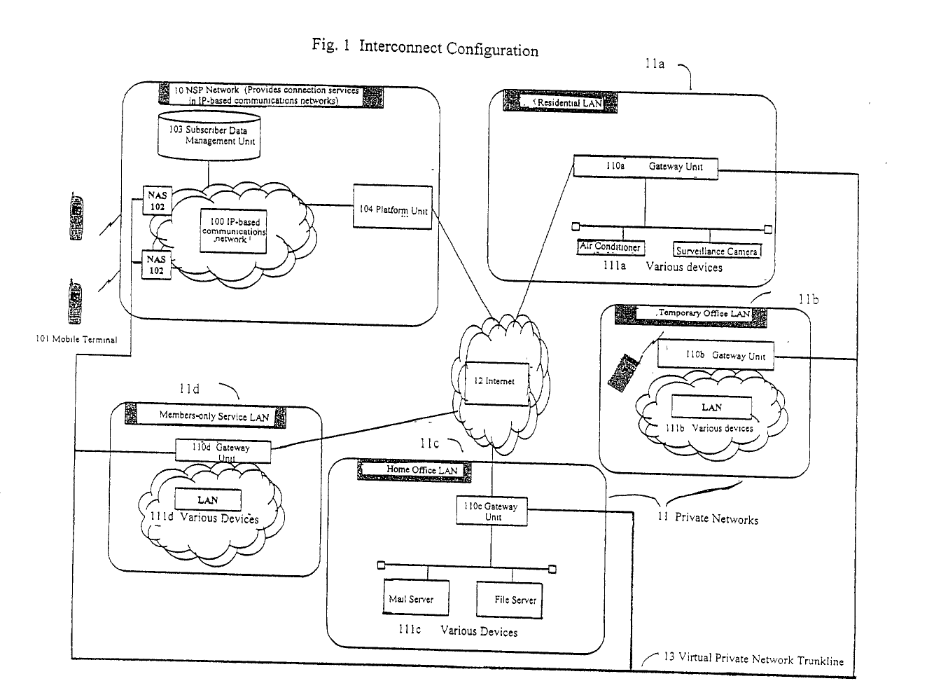

An interconnect configuration between the various private networks and the network service provider (NSP) is detailed in FIG. 1. A NSP network 10 provides connection services for the mobile terminals 101 in an IP-based communications network 100 including a subscriber data management unit 103 for supporting mobile terminals 101, and a platform unit 104 connected to the subscriber data management unit 103 within the NSP network 10. The platform unit 104 includes the necessary connections to various private networks 11a, 11b, 1c or 11d through an Internet 12. The platform unit 104 receives inquiries from the gate units 110a, 110b, 110c and 110d in the private networks 11a, 11b, 11c and 11d requesting subscriber information for authorization to communicate with other private network local area networks (LAN) 11a-11d or the devices therein 111a, 111b, 111c and 11d, or with the mobile terminals 101. The platform unit 104 in response to the inquiries, queries the subscriber data management unit 103 and recognizes the subscriber status. The platform unit 104 may deny access to the requested device or LAN if the results are negative.

If positive, the platform unit 104 provides the routines necessary from the stored programs for commanding that a network access server (NAS), or an equivalent access router 102 to which the mobile terminals 101 are connected, issue connection authorization data for the mobile terminals. The platform unit 104 also provides the necessary routines for transmitting authorization data to the NAS (or access router) 102 connected to the mobile terminals 101. Those commands include routines for connecting the various private networks 11, thus establishing links to the mobile terminals 101 when such connection requests are made by the private networks 11.

The platform unit establishes a virtual private network (VPN) connection 13, or the equivalent to a VPN connection 13 when required by the security protocol of the private network. The VPN 13 provides a secure communication path between the gateway unit 110a-110d in the private networks and the NAS units or access servers or routers. The NAS (or access router) 102 provides the routines for establishing a VPN 13 or equivalent connection to the gateway unit 110 in the private network 11.

A private network 11 may include a gateway unit 110 and various devices 111. For connection requests received from a mobile terminal 101, the gateway unit 110 sends a connection authorization request to the platform unit 104 in the NSP network 10 which queries the subscriber data management unit 103 in the NSP network 10, to determine whether the requested connection is authorized. If authorized, the connection authorization data for the requesting mobile terminal 101 is transmitted by the NAS 102. The gateway unit 110 performs connection control by packet filtering which uses the source IP address that was contained in the connection authorization data. Depending on the security policy of the targeted private network 11, the gateway unit 110 in that private network may include an application for establishing a VPN 13 or a comparable connection between the platform unit 104 and a NAS, or access router, 102 and the mobile terminal 101. If required, the gateway unit 110 may also include a network IP address translation (NAT) function or another comparable routine for use within the private network 11. (For instance, IP MASQUERADE™ which is used in the LINUX™ operating system would be a comparable translation function). In the event that the devices 111 within a private network 11 have global IP addresses, the gateway unit 110 might include a routine for directly routing the follow-on communications to the devices 111 from outside the private network. This allows direct communication between a device 111 and a mobile terminal 101.

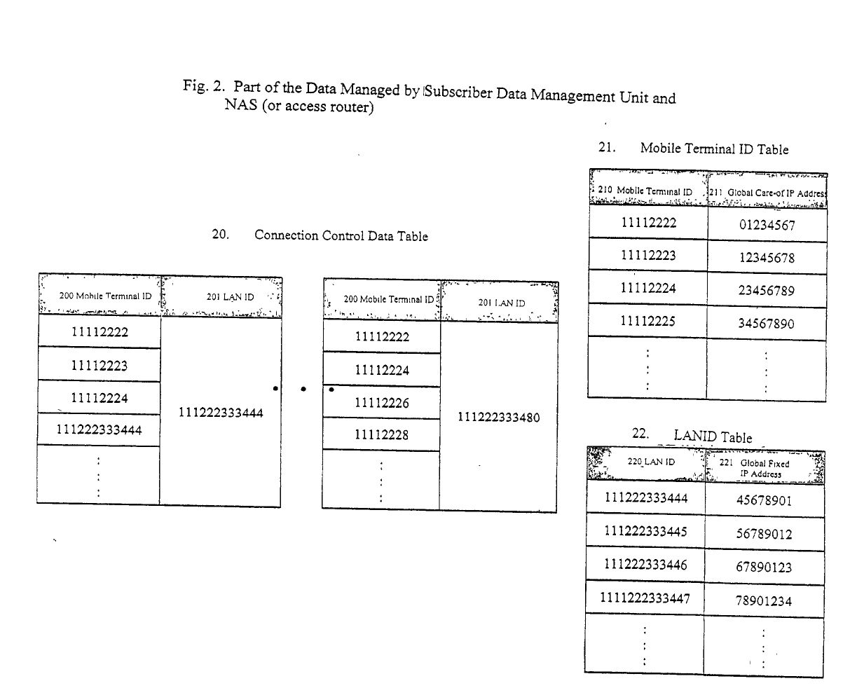

FIG. 2 shows a portion of the data managed by the subscriber data management unit 103, containing the subscriber data, and the NAS (or access router) units 102, in the NSP network 10. The subscriber data management unit 103 manages the connection control Table 20, the mobile terminal ID (UID) Table 21, and the LANID Table 22. The connection control table 20 contains functions for the data management of the mobile terminal IDs (UIDs) 200 generated for the mobile terminals 101 by the NSP. The LANIDs 201 are generated by the NSP for each private network. The subscriber data unit also tracks the relationships between the private network LANs 201 and the UIDs 200 for the plurality of constituents (employees, family members, members of a service, etc.) for whom permission to connect to various private networks 11 has been granted through assigned IDs.

Similarly, the LANID Table 22 includes routines for the data management of IDs generated for each of the private networks 11 by the NSP (LANIDs) 220, and data such as the global fixed IP addresses 221 maintained in possession of the gateway units 110 in the private networks 11.

The UID Table 21 is managed by the NASs (or access routers) 102. In the mobile terminal ID Table 21, there are functions for performing data management of UIDs 210 generated for the mobile terminals 101 by the NSP and the mobile terminal 101 current global “care-of” IP addresses 211.

Described below are some examples of the communication security authentication methodologies for illustrative purposes:

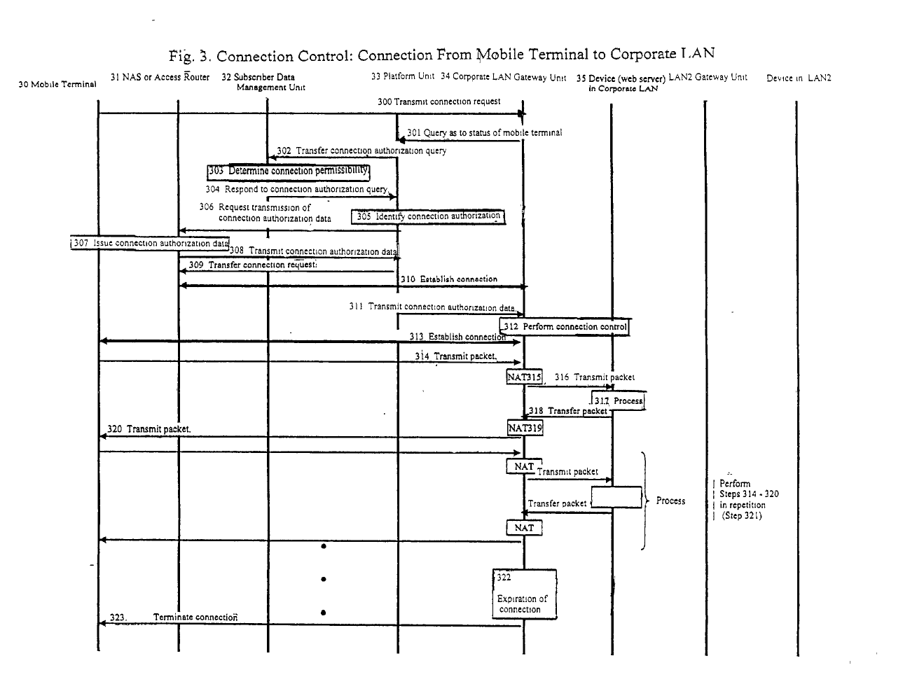

FIG. 3 illustrates the first example in which a user (e.g., a businessman) establishes a connection from his personal mobile terminal to an intranet (a web server having a private IP address) within a corporate LAN. A user's mobile terminal 30 requests a connection to a web server 35 in a corporate LAN, or alternatively, the mobile terminal 30 may transmit an initial packet requesting information from the server. Either way, the message is treated as a connection request by the gateway unit 34 in the corporate LAN (Step 300).

Upon receiving the initial message, the gateway unit 34 in the corporate LAN connects to a platform unit 33 located in the NSP network and performs a query to determine whether the requested connection is authorized (Step 301). The platform unit 33 queries a subscriber data management unit 32 in the same NSP (Step 302) to determine whether the mobile terminal 30 can be connected to the corporate LAN (Step 303), and transmits the response to the platform unit 33 (Step 304). Upon receipt, the platform unit 33 identifies whether the connection is authorized or not (Step 305), and if it is, the platform unit 33 commands the NAS, or an equivalent 31, to which the mobile terminal 30 is connected, to issue connection authorization data for the mobile terminal 30 (Step 306).

The authorization data subsequently generated (Step 307) and transmitted (Step 308) is also transmitted to the gateway unit 34 in the corporate LAN 35 (Step 311). This connection authorization data might be, for example, data generated from the global IP address of the mobile terminal 30 for packet filtering by a source IP address, or for example, TCP port numbers of packets that are to be allowed to pass through. In compliance with the private network security policies, the NAS or access router can also connect to the gateway unit in the corporate LAN using a VPN (Steps 309 and 310). It may be desirable to use a VPN 13 prior to Step 311 to avoid message exposure to surreptitious interception.

Based on the above connection authorization data, the gateway unit 34 in the targeted corporate LAN will provide connection control (Step 312). It can execute a VPN-type connection (Step 313) if needed. Packets transmitted from the mobile terminal 30 (Step 300 or 314) arrive at the gateway unit 34 in the corporate LAN. The packets undergo IP address translation processing (NAT, etc.) to authenticate the source of the information. This ensures the identity of the requesting mobile terminal (Step 315). The packets are transmitted to the web server 35 in the targeted corporate LAN (Step 316), and the messages are processed (Step 317). Reply packets processed in Step 317 are sent to the gateway unit 34 in the corporate LAN (Step 318), undergo IP address translation (Step 319) and are transmitted to the mobile terminal (Step 320). Thereafter, Steps 314 through 320 may be repeated (Step 321). The authorization data used for the connection control in Step 312, which is peculiar to the gateway unit 34 in the corporate LAN, has a set lifetime. Upon expiration (Step 322), the connection may be terminated (Step 323).

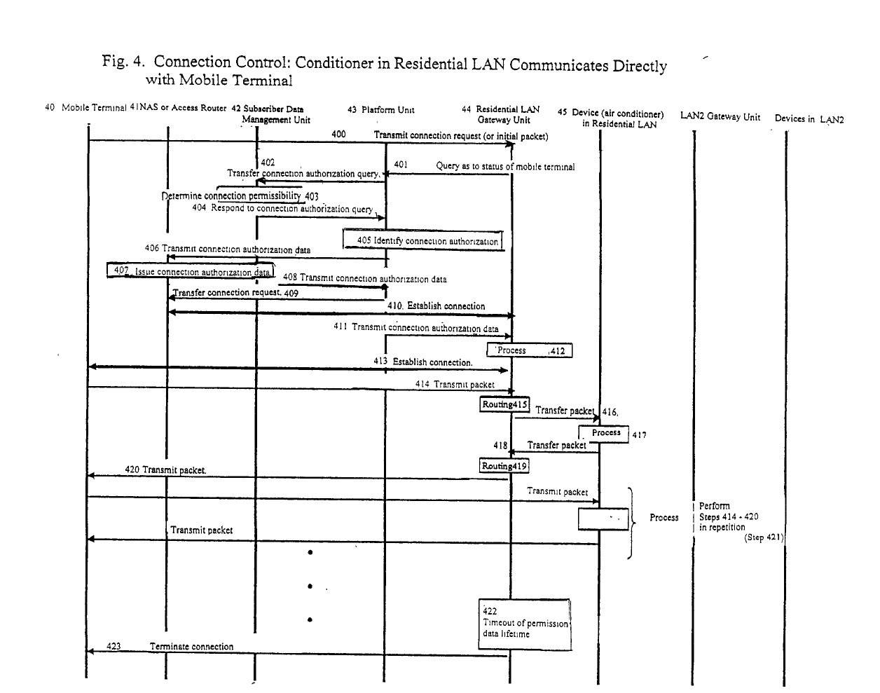

The second example, as illustrated in FIG. 4, describes the connection of a device within a private network to a mobile terminal, and the targeted device has a global IP address. The request will originate from the mobile terminal. For example, a family member wants to cool the house before arriving home at the end of a work day. Using the mobile terminal this desire is communicated directly to the home air conditioner, which is connected to the family's residential LAN.

The family member's mobile terminal 40 requests a connection to the air conditioner 45 connected to the family's residential LAN, or the mobile terminal alternatively transmits an initial packet which is interpreted as making the request. The request is sent to the gateway unit 44 in the residential LAN (Step 400). Upon receiving the connection request, the gateway unit 44 in the residential LAN connects to a platform unit 43 in an NSP network and performs a query to determine whether the requested connection is authorized (Step 401). The platform unit 43 queries a subscriber data management unit 42 in the NSP (Step 402) to determine whether the mobile terminal 40 can be connected to the residential LAN (Step 403), and transmits a response to the platform unit (Step 404). Upon reception, the platform unit 43 identifies the authorization (Step 405), and, if granted, commands the NAS (or access router) 41 connecting the mobile terminal 40 to issue connection authorization data to the mobile terminal 40 (Step 406).

The authorization data is recognized at the NAS (Step 407) and is acknowledged to the platform unit 43 (Step 408), where it is further transmitted to the gateway unit 44 in the residential LAN in Step 411. This authorization data might take the form of data generated from the global IP address of the mobile terminal 40 for the purpose of packet filtering by source IP address. Again, these might be TCP port numbers of packets that are allowed to pass through. In accordance with private network security policies, the NAS (or an equivalent access router) may connect to the gateway unit in the residential LAN using a VPN 13 or VPN-type connection (Steps 409 and 410). It may also be desirable to use such a VPN connection 13 prior to Step 411, to avoid making connections where a surreptitious interception of the data might occur.

Based on the protocol of the authorization data, the gateway unit 44 in the targeted residential LAN performs connection control (Step 412) executing the VPN 13 or VPN-type connection to grant the request (Step 413). Packets are transmitted from the mobile terminal 40 (Step 400 or 414) and arrive at the gateway unit 44 in the residential LAN, and since the air conditioner has a global IP address, the gate unit 44 simply routes the packets (Step 415) directly to the air conditioner 45 in the residential LAN (Step 416), where they are processed (Step 417). Packets processed in Step 417 are again sent to the gateway unit 44 in the residential LAN (Step 418), where they are routed (Step 419), and transmitted to the mobile terminal 40 (Step 420). Thereafter, Steps 414 through 420 may be repeated (Step 421). The authorization data used for connection control in Step 412 (which is peculiar to the gateway unit 44 in the residential LAN) may prescribe a set lifetime. Upon expiration (Step 422), the connection will terminate (Step 423).

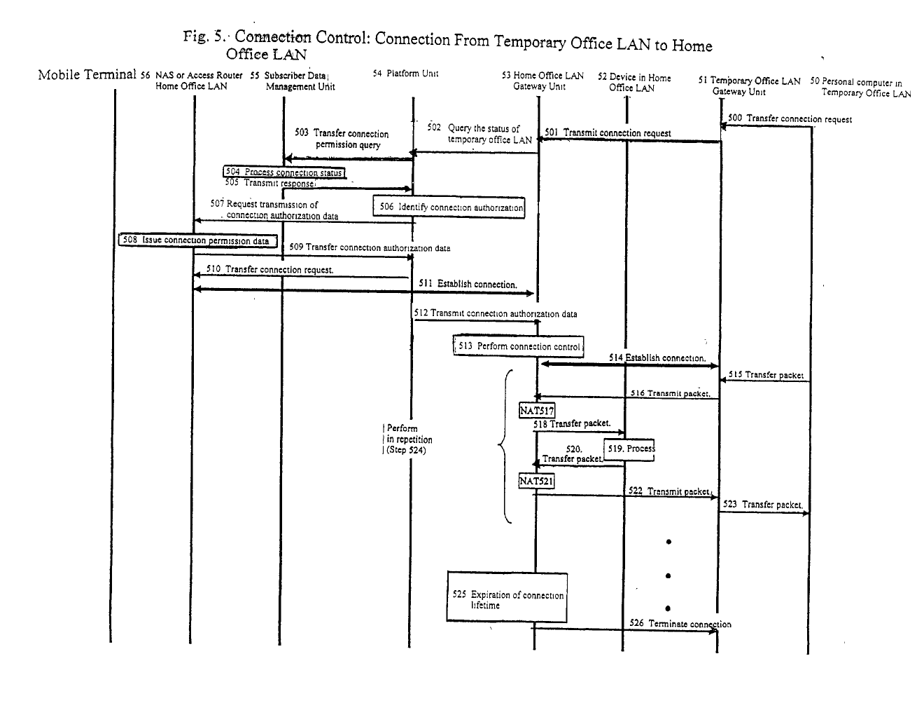

Referring to FIG. 5, the third example illustrates a connection between two LANs, where one LAN requests the connection through a mobile terminal that uses the NSP for connecting to the Internet. In this example, the user of a personal computer connected to a temporary office LAN connects to an intranet (a server with a private IP address) existing within his firm's home office LAN.

A personal computer 50 in the temporary office LAN requests a connection to a web server 52 in the home office LAN, or otherwise transmits an initial packet of information which is interpreted as the request (Step 500). This connection request is transmitted from the mobile terminal, which is connected directly to the gateway unit 51 in the temporary office LAN, to the gateway unit 53 in the home office LAN (Step 501). The mobile terminal in this case may include a satellite transceiver directly connected to the temporary office LAN.

Upon receiving the connection request, the gateway unit 53 in the home office LAN connects to a platform unit 54 in the NSP network, and performs a query as to the permissibility of the requested connection (Step 502). The platform unit 54 queries the subscriber data management unit 55 residing in the NSP (Step 503) to determine whether the mobile terminal or satellite transceiver used by the gateway unit 51 of the temporary office LAN is authorized to connect to the home office LAN (Step 504), and responds to the platform unit 54 (Step 505). Upon receipt, the platform unit 54 identifies whether the connection is authorized (Step 506) and commands the NAS (or access router) 56 connected to the mobile terminal to issue connection authorization data for the mobile terminal that is connected to the gateway 51 in the temporary office LAN (Step 507). The authorization data subsequently issued (Step 508) and acknowledged by the platform unit 54 (Step 509) is then transmitted to the gateway unit 53 in the home office LAN (Step 512). The connection authorization data may be data generated from the global IP address of the mobile terminal 56 for packet filtering by source IP address. In other words, the filtering may be accomplished by identifying the TCP port numbers of the packets authorized to pass through the gateway unit 51.

The private network security policies might establish protocols by which a NAS (access router) can connect to the gateway unit 53 in the home office LAN using a VPN-type 13 connection (Steps 510 and 511). It may be desirable to use such a VPN connection 13 prior to Step 512, to avoid any surreptitious interceptions of the data. Based upon the connection authorization data, the gateway unit 53 in the targeted home office LAN performs the connection control (Step 513) and may execute a VPN-type connection 13 to establish the requested communication (Step 514). Packets transmitted from the personal computer 50 in the temporary LAN (Steps 515 and 516, or 500 and 511) arrive at the gateway unit 53 in the home office LAN. The packets undergo IP address translation processing (NAT, etc.) if required (Step 517), and are transmitted to the web server 52 in the home office LAN to which the connection was made (Step 518). The information is then processed in the web server 52 (Step 519). Response packets processed in Step 519 are sent to the gateway unit 53 in the home office LAN (Step 520), undergo IP address translation (Step 521), and are transmitted to the gateway unit 51 in the temporary office LAN (Step 522). Once the message is in the temporary office LAN, it is transferred to the personal computer 50 (Step 523). From that point on, Steps 515 through 523 may be repeated as necessary (Step 524).

The connection authorization data used for connection control Step 513 is peculiar to the corporate LAN gateway unit 53. It may include a set lifetime. Upon expiration (Step 525), the connection is terminated (Step 526).

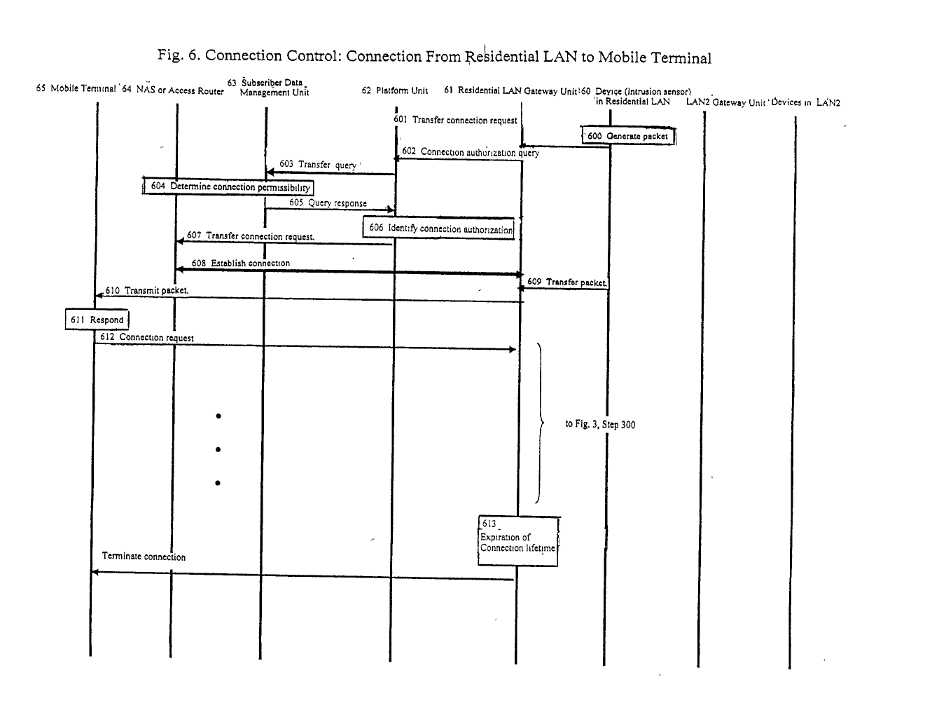

Referring to FIG. 6, the fourth example illustrates a request for a connection from a private network to a mobile terminal. In this example, an intrusion sensor connected to a residential LAN detects an intruder. The resulting alarm is forwarded to the mobile terminal in possession of the traveling family.

When the intrusion sensor 60 in the residential LAN generates an ‘intruder information detected’ packet (Step 600), it transmits a connection request for a family member's mobile terminal 65 (or transmits the initial packet of information). The request is transmitted to a gateway unit 61 in the residential LAN (Step 601). Upon receiving the connection request, the gateway unit 61 in the residential LAN connects to a platform unit 62 in a NSP network and performs a query to determine whether the requested connection is authorized (Step 602). The platform unit 62 queries a subscriber data management unit 63 in the NSP (Step 603) which determines whether the gateway unit 61 in the residential LAN is authorized to connect to the mobile terminal (Step 604) and responds to the platform unit (Step 605). The platform unit 62 identifies whether the connection authorization is granted (Step 606), but since the NAS (or access router) 64 in the NSP cannot issue connection control data for the gateway unit 61 in the residential LAN, the platform unit 62 sends the connection request to the NAS 64 connected to the mobile terminal (Step 607). The NAS (or access router) 64 may establish a VPN-type 13 connection to the gateway unit in the residential LAN (Step 608). As packets are transmitted from the intrusion sensor 60 (Step 609 or 601) and arrive at the gateway unit 61 of the residential LAN, they are directed to the mobile terminal 65 by the gateway unit 61 of the residential LAN (Step 610). The mobile terminal 65 replies to the packet transmission from the intrusion sensor in the residential LAN, and requesting a connection, if necessary (Step 612). Operation from this point through termination of the connection is as depicted in FIG. 3.

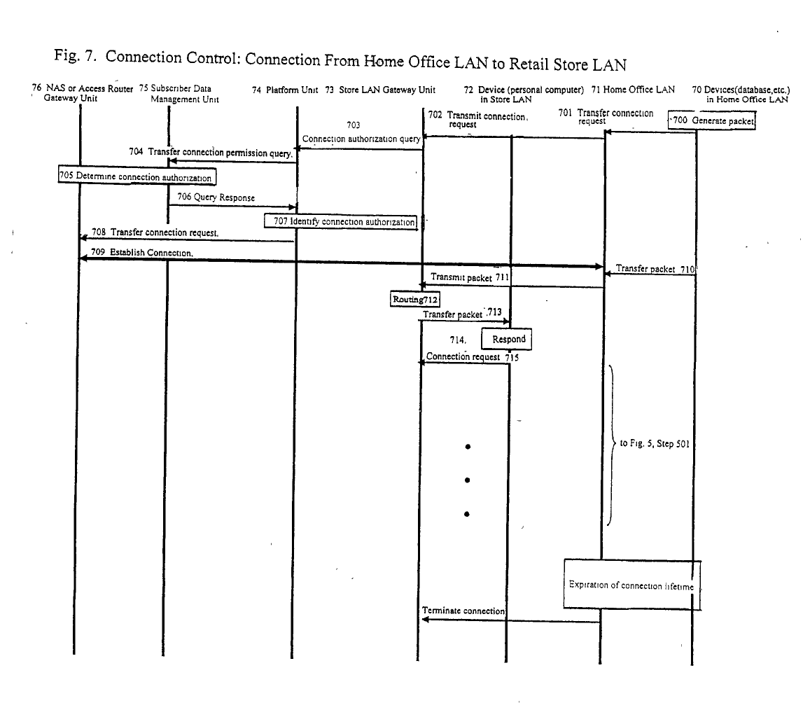

FIG. 7 illustrates an example for establishing a connection between two private networks wherein the targeted LAN uses a mobile terminal that belongs to a NSP network for connecting to the Internet. The mobile terminal in this example may be a satellite transceiver. In this example, the connection is established to provide notification of updated data residing in a database in the home office LAN. The database has a private IP address. The target for the update is a personal computer connected to a retail store LAN and this LAN utilizes the mobile terminal, and the NSP network for connecting to the Internet.

A database 70 in the home office LAN generates an update notification packet (Step 700), and requests a connection to the retail store LAN or otherwise transmits an initial packet requesting information. The connection request is sent to the gateway unit 71 in the home office LAN (Step 701). As requested, the gateway unit 71 in the home office connects to the mobile terminal used by a gateway unit 73 in the store LAN, and transmits the connection request to the gateway unit 73 in the store LAN (Step 702). The store LAN gateway unit 73 receiving the connection request connects to a platform unit 74 in the member NSP network for the mobile terminal and queries the platform unit 74 as to whether the requested connection is authorized (Step 703). The platform unit 74 queries the subscriber data management unit 75 in the same NSP network (Step 704), determining whether the gateway unit 71 of the home office LAN is authorized to connect to the store LAN 73 (Step 705), and transmits the appropriate response to the platform unit 74 (Step 706). Upon receipt, the platform unit 74 identifies the authorization data (Step 707). Since the NAS, or access router, in its own network cannot issue connection control data for the gateway unit in the home office LAN, it sends another connection request, or an initial packet requesting information, to the NAS, or access router, 76 connected to the mobile terminal used by the gateway unit 73 in the store LAN (Step 708).

The NAS, or access router, 76 may establish a VPN, or equivalent, connection 13 to the gateway unit in the home office LAN (Step 709). Packets transmitted from the home office's database 70 (Step 710 or 701) arrive at the gateway unit 71 of the home office LAN and are transmitted to the gateway unit 73 of the store LAN (Step 711). The gateway unit 73 in the store LAN performs routing (Step 712) to transmit the packets received from the database 70 in the home office LAN to the personal computer 72 in the store LAN (Step 713). The personal computer 72 analyzes, manipulates and stores the data (Step 714) and acknowledges the packets (Step 715), and if necessary, requests a connection. At this point, the operation may be as depicted in FIG. 5.

While various embodiments of the invention have been described, it will be apparent to those of ordinary skill in the art that more embodiments and implementations are possible that are within the scope of the invention.

We claim:

1. A NSP network to provide a platform service in an IP-based communications network, including means for connecting to various private networks, a subscriber data management unit for mobile terminals using the network, and a platform unit connected to the subscriber data management unit, the platform unit comprising:
an application to query the subscriber data management unit to obtain subscriber data about mobile terminals and private networks, and identify the results of the query;
an application to command a NAS or access router connected to a mobile terminal to transmit connection authorization data for the mobile terminal to connect with the private network; and
an application to command at least one of the NAS and access router connected to the mobile terminal to connect a VPN between the mobile terminal and private network when requested by the private network.

2. The NSP network as recited in claim 1, wherein the platform unit comprises an application to command a NAS or access router connected to a mobile terminal to transmit connection authorization data for the mobile terminal to connect with the private network when the mobile terminal requests a connection to a private network.

3. The NSP network as recited in claim 1, wherein the platform unit comprises an application to command a NAS or access router connected to a mobile terminal to transmit connection authorization data for the mobile terminal to connect with the private network when the private network requests a connection to the mobile terminal.

4. The NSP network as recited in claim 1, wherein the subscriber data management unit stores NSP subscriber membership information and comprises an application for managing data with respect to subscriber member UIDs and LANIDs, that are issued and assigned by the NSP, wherein relationships have been assigned with respect to a plurality of constituents for which access to various private networks has been granted.

5. The NSP network as recited in claim 4 wherein the subscriber data management unit comprises a relationship-assigning function whereby a mobile terminal having permission to connect to a plurality of local area networks, said mobile terminal ID being assigned relationships to the plurality of LANIDs.

6. A platform unit located in a NSP network for providing connection control in response to a member mobile terminal requesting a connection to a device in a private network directed at a private network gateway unit, comprising:
an application for responding to the private network gateway unit's query determining whether the mobile terminal's requested connection is authorized;
an application for querying a subscriber data management unit in the NSP and determining whether the mobile terminal is authorized to connect to the private network;
an application for when the connection is authorized, the platform unit transmits connection authorization data for the mobile terminal to at least one of the NAS and the access router connected to the mobile terminal, and transmits connection authorization data to the gateway unit in the private network; and
an application when required by the private network security protocol, the platform unit transmits to at least one of the NAS and access router connected to the mobile terminal, a connection request to provide a VPN connection between the gateway unit in the private network and the NAS.

7. The platform unit as recited in claim 6 comprising routines for automatically translating a LANID into a global IP address of a gateway unit in a private network to establish a connection to said gateway unit.

8. The platform unit as recited in claim 6, when a private network to which the connection is requested uses a mobile terminal in the same NSP network to connect to the Internet, performs connection control using connection authorization data transmitted to at least one of the NAS and access router connected to the mobile terminal, or performs connection control by transmitting a VPN connection request to at least one of the NAS and access router.

9. The platform unit as recited in claim 6, wherein the platform unit performs connection authorization processing in response to the connection request from the mobile terminal, and in accordance with the security policy of the private network, establishes the VPN connection with the gateway unit in the private network, or the VPN connection being established between a mobile terminal and the gateway unit in response to the VPN connection request from the platform unit.

10. The platform unit as recited in claim 6 wherein the subscriber data management unit stores NSP subscriber membership information and manages data with respect to member UIDs that are issued for member mobile terminals by the NSP and LANIDs that are issued for private networks by the NSP, accessible by members, wherein relationships have been assigned with respect to a plurality of constituents for which access to various private networks has been granted.

11. The platform unit as recited in claim 10, wherein the subscriber data management unit comprises a relationship-assigning routine, where the mobile terminal being a member to a plurality of LANs, the mobile terminal ID is assigned relationships to the plurality of corresponding LANIDs.

12. The platform unit as recited in claim 6, in response to the mobile terminal connection authorization query from the private network gateway unit, wherein the platform unit queries the subscriber data management unit in the NSP for determining a member status with respect to mobile terminals transmitting connection requests, where the connection authorization data is transmitted from the NAS to the mobile terminal requesting the connection and the NAS performs connection control through packet filtering by a source IP address in accordance with the connection authorization data, comprising:
an application for establishing the VPN connection between the platform unit, the NAS router and the mobile terminal;
a NAT IP address translation application for connections within the private network; and
an application for routing of messages to the devices within a private network having global IP addresses which provide a direct connection between the mobile terminal and the device.

13. The platform unit as recited in claim 12 wherein the mobile terminal comprises an application for a mobile IP other than a Route Optimization application, and the mobile IP makes a direct VPN connection to the gateway unit in the private network as required by the security policy of the private network.

14. The platform unit as recited in claim 6, wherein, during the transmission of connection authorization data, at least one of the NAS and access router in the NSP:
records data comprising an UID, a recent care-of address of the mobile terminal, packet filtering by source IP address, and a lifetime of the present connection permission data; and
establishes the VPN connection to the gateway unit in the private network, in response to the VPN connection request from the platform unit.

15. The platform unit as recited in claim 6, wherein an initial packet from the mobile terminal requesting a connection functions as a connection request.

16. A platform unit located in a NSP network for providing connection control in response to a private network requesting a connection to a NSP member mobile terminal comprising:
an application for responding to the private network gateway unit's request by determining whether the requested connection is authorized;
an application for querying a subscriber data management unit in the NSP and determining whether the private network is authorized to connect to the mobile terminal;
an application for when the connection is authorized, the platform unit transmits connection authorization data for the mobile terminal to at least one of the NAS and the access router connected to the mobile terminal, and transmits connection authorization data to the gateway unit in the private network; and
an application when required by the private network security protocol, the platform unit transmits to at least one of the NAS and access router connected to the mobile terminal, a connection request to provide a VPN connection between the gateway unit in the private network and the NAS.

17. A platform unit as recited in claim 16 comprising routines for automatically translating a LANID into a global IP address of a gateway unit in a private network, to establish a connection to said gateway unit.

18. A platform unit as recited in claim 16, when a private network from which the connection is requested uses a mobile terminal in the same NSP network to connect to the Internet, performs connection control using connection authorization data transmitted to at least one of the NAS or access router connected to the mobile terminal, or performs connection control by transmitting a VPN connection request to at least one of the NAS and access router.

19. A platform unit as recited in claim 16, wherein the platform unit performs connection authorization processing from the connection request from the private network, and in accordance with the security policy of the private network, the platform unit establishes the VPN connection with the gateway unit in the private network, or the VPN connection being established between the mobile terminal and the gateway unit in response to a request from the platform unit.

20. The platform unit as recited in claim 16 wherein the subscriber data management unit stores NSP subscriber membership information and manages data with respect to member UIDs that are issued for member mobile terminals by the NSP and LANIDs that are issued for private networks by the NSP, accessible by members, wherein relationships have been assigned with respect to a plurality of constituents for which access to various private networks has been granted.

21. The platform unit as recited in claim 20, wherein the subscriber data management unit comprises a relationship-assigning routine, the mobile terminal being a member to a plurality of LANs, the mobile terminal ID being assigned relationships to the plurality of corresponding LANIDs.

22. The platform unit as recited in claim 16, in response to the private network request for connection to the mobile terminal from the private network gateway unit, wherein the platform unit queries the subscriber data management unit in the NSP for determining a member status with respect to private networks transmitting connection requests to mobile terminals, where the connection authorization data is transmitted from the NAS to the targeted mobile terminal and the NAS performs connection control through packet filtering by a source IP address in accordance with the connection authorization data, comprising:
an application for establishing the VPN connection between the platform unit, the NAS router and the mobile terminal;
a NAT IP address translation application for connections within the private network; and
an application for routing of messages from the devices within a private network having global IP addresses which provide a direct connection between the mobile terminal and the device.

23. The platform unit as recited in claim 22 wherein the mobile terminal comprises an application for a mobile IP other than a Route Optimization application, and the mobile IP makes a direct VPN connection to the gateway unit in the private network as required by the security policy of the private network.

24. The platform unit as recited in claim 16, wherein, during the transmission of connection authorization data, at least one of the NAS and access router in the NSP:
records data comprising an UID, a recent care-of address of the mobile terminal, packet filtering by source IP address, and a lifetime of the present connection permission data; and
establishes the VPN connection to the gateway unit in the private network, in response to the VPN connection request from the platform unit.

25. The platform unit as recited in claim 16, wherein an initial packet from the mobile terminal requesting a connection functions as a connection request.
